(19) United States
(12) Patent Application Publication
(10) Pub. No.: US 2008/0208682 A1
(43) Pub. Date: Aug. 28, 2008

(54) Revenue Generation and Sharing for Content Sharing Services

(75) Inventors: ADRIAN M. CHANDLEY, SAMMAMISH, WA (US); KEITH D. SENZEL, SEATTLE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/677,931

(22) Filed: Feb. 22, 2007

(51) Int. Cl. G06Q 30/00

(52) U.S. Cl. 705/14

(57) ABSTRACT

Generating advertising revenue for a content sharing service is provided herein. Content received from content contributors at a content sharing service is parsed to identify items for which affiliate advertising links may be provided. Affiliate advertising links are then added to the content based on the identified items. The affiliate advertising links include an affiliate ID associated with the content sharing service such that advertising revenue generated via the affiliate advertising links is attributed to the content sharing service.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

The Internet has allowed users to access a continuously increasing amount of content. One way in which users may access content through the Internet is via content sharing services, which include the variety of web sites, web services, and connected applications that provide for online collaboration and content-sharing among multiple users. In particular, a content sharing service allows content contributors to publish content to the content sharing service and other consuming users to access and consume the published content.

There are a wide variety of content sharing services, including wikis, social communities, music-sharing services, and photo-sharing services to name a few. Often, a particular content sharing service will target a specific area or topic. For instance, a recipe-sharing service may be directed to sharing recipes, thereby allowing cooking enthusiasts to publish their favorite recipes, as well as access recipes contributed by other cooking enthusiasts.

Accordingly, content sharing services often serve as vital resources to the online communities that employ them. However, content sharing services rely on the contribution of content from users. Accordingly, if a content sharing service is unable to receive sufficient user contribution to reach a critical mass of content, the content sharing service will not be a viable resource. Additionally, even if a content sharing service obtains a critical mass of content, the content sharing service typically requires some form of revenue to maintain and operate the service. However, content sharing services are often provided to users free of any charge or at only a nominal charge.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the invention relate to generating advertising revenue at a content sharing service via affiliate advertising programs. Content received from content contributors at a content sharing service is parsed to identify items for which affiliate advertising links may be provided. Affiliate advertising links are then added to the content based on the identified items. The affiliate advertising links include an affiliate ID associated with the content sharing service such that advertising revenue generated via the affiliate advertising links is attributed to the content sharing service.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram of an exemplary system in which embodiments of the present invention may be employed;

FIG. 3 is a flow diagram showing an exemplary overall method for adding affiliate advertising links to content provided to a content sharing service from a content contributor in accordance with an embodiment of the present invention;

FIG. 4 is a flow diagram showing an exemplary method for adding an affiliate advertising link for a content item identified within content contributed to a content sharing service in accordance with an embodiment of the present invention;

FIG. 5 is a flow diagram showing an exemplary method for sharing advertising revenue generated at a content sharing service with a content contributor in accordance with an embodiment of the present invention; and

FIG. 6 is a flow diagram showing an exemplary method for tracking advertising revenue generated by affiliate advertising links in content from multiple content contributors in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide for, among other things, generating advertising revenue at content sharing services by employing affiliate advertising programs and adding affiliate advertising links to content provided by content contributors. In some embodiments, advertising revenue generated by a content sharing service may be shared with content contributors.

As is known in the art, an affiliate advertising program is a performance-based system in which an affiliate is compensated for referring traffic to an advertiser. For instance, the affiliate may maintain a web site that includes an affiliate advertising link to the advertiser's web site. The affiliate advertising link comprises a uniform resource locator (URL) corresponding to the advertiser's site that includes an affiliate identifier (ID) to facilitate the recognition that traffic was referred to the site by a particular affiliate. As used herein, an advertiser refers to any entity providing compensation to one or more affiliates via an affiliate advertising program, and may include, for example, a web merchant, a service provider, and a polling company.

Affiliate advertising programs may employ a number of different compensation models. By way of example only and not limitation, in some cases, an affiliate advertising program may employ a pay-per-click compensation model, in which a certain amount of compensation is attributed to an affiliate each time a user clicks on the affiliate's affiliate advertising link. In other cases, an affiliate advertising program may employ a pay-per-lead compensation model, in which compensation is provided each time a user (who was referred by the affiliate advertising link) performs an action (other than a purchase) desired by the advertiser, such as, for example, filling out a form or survey, creating an account, or registering for a service. In further cases, an affiliate advertising program may employ a pay-per-sale compensation model, in which compensation is provided based on the completion of sales. Typically, the compensation is a percentage of the sale amount. In still further cases, an affiliate advertising program may employ a combination of compensation models. For instance, an affiliate advertising program may provide compensation on both a pay-per-click basis and a pay-per-sale basis.

In embodiments, when a content contributor provides content to a content sharing service, the content is parsed to identify items for which affiliate advertising links may be added to the content. Identification of content items may include identifying any type of item within content that may be used to select an advertiser and for which an affiliate advertising link may be added. For instance, a content item may comprise a URL, text, an image, or another type of item. The method by which an affiliate advertising link is added to the content may vary based on the identified item. For instance, in some embodiments, an identified item may be a URL to a particular advertiser, and adding an affiliate advertising link may include converting that URL to an affiliate advertising link. In other embodiments, an identified item may be text, and adding an affiliate advertising link may include selecting an advertiser based on the text and adding an affiliate advertising link to that advertiser. In still other embodiments, other types of content items may be identified and serve as a basis for adding affiliate advertising links to content.

Each affiliate advertising link added to content from content contributors include an affiliate ID associated with the content sharing service. Accordingly, when advertising revenue is generated via an affiliate advertising link, the advertising revenue is allocated to the content sharing service. In some embodiments, the content sharing service may then share at least a portion of the revenue with the content contributor whose content included the affiliate advertising link.

Accordingly, in one aspect, an embodiment of the present invention is directed to one or more computer-readable media embodying computer-useable instructions for performing a method of automatically generating affiliate advertising links for content provided by a content contributor to a content sharing service. The method includes receiving content associated with the content contributor at the content sharing service. The method also includes parsing the content to identify one or more items within the content. The method further includes adding at least one affiliate advertising link to the content based on at least one of the items identified within the content, the at least one affiliate advertising link being associated with the content sharing service such that revenue generated via the affiliate advertising link is allocated to the content sharing service.

In another embodiment of the invention, an aspect is directed to a method for sharing advertising revenue generated by a content sharing service with a content contributor. The method includes receiving content at the content sharing service from the content contributor. The method also includes parsing the content to identify one or more items for inserting one or more affiliate advertising links. The method further includes adding at least one affiliate advertising link to the content, the at least one affiliate advertising link being associated with the content sharing service. The method also includes receiving at least an allocation of advertising revenue at the content sharing service from at least one advertiser associated with the at least one affiliate advertising link. The method still further includes sharing at least a portion of the advertising revenue with the content contributor.

In a further aspect of the invention, an embodiment is directed to a computer-implemented method for tracking advertising revenue generated by affiliate advertising links inserted into content provided by content contributors to a content sharing service. The method includes receiving content from a content contributor at the content sharing service. The method also includes parsing the content to identify at least one item for inserting an affiliate advertising link. The method further includes providing a link in the content without including an affiliate advertising identifier in the link. The method also includes receiving a selection of the link from a consuming user. The method still further includes retrieving an affiliate advertising identifier from a pool of affiliate advertising identifiers for an affiliate advertising program and attaching the retrieved affiliate advertising identifier to the link to create an affiliate advertising link. The method additionally includes associating the retrieved affiliate advertising identifier with the content contributor, thereby allowing for advertising revenue generated based on the affiliate advertising link to be tracked and associated with the content contributor.

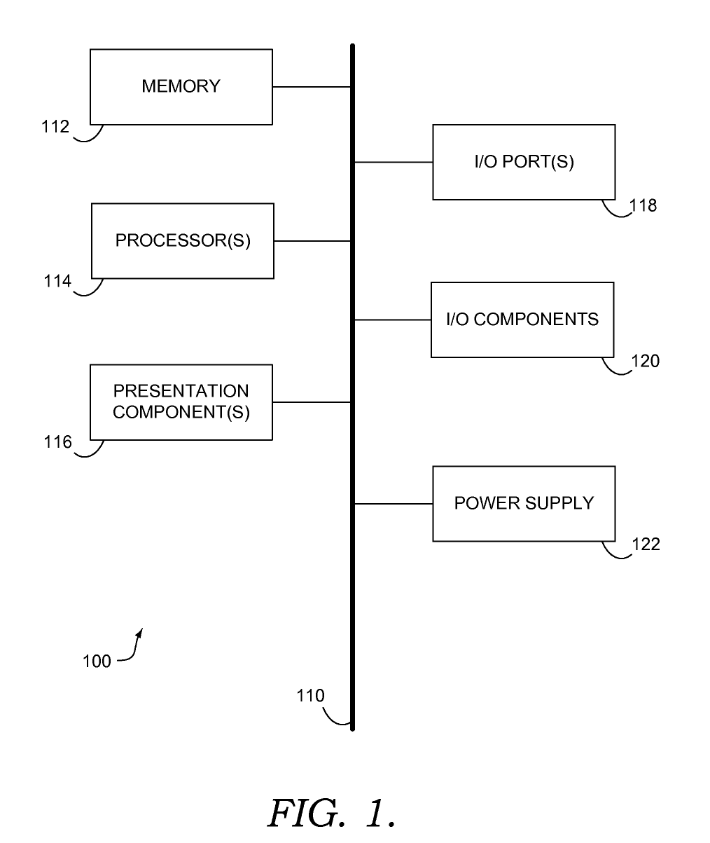

Having briefly described an overview of the present invention, an exemplary operating environment in which various aspects of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

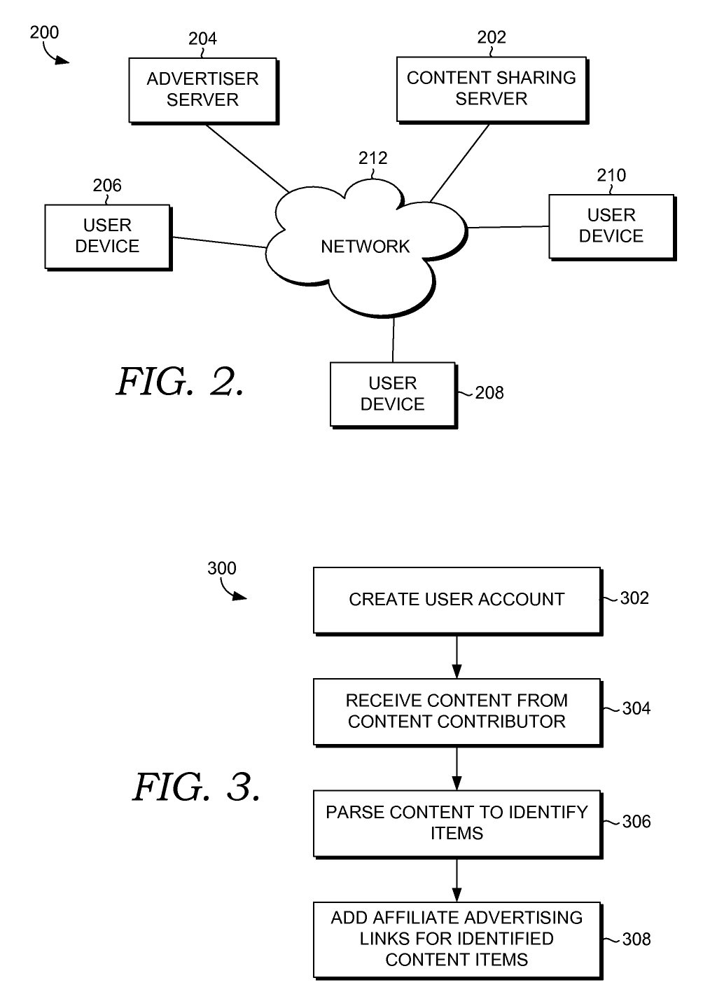

Referring now to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 may include a content sharing server 202, an advertiser server 204, and a number of user devices 206, 208, 210. Each of the content sharing server 202, advertiser server 204, and user devices 206, 208, 210 may be any type of computing device, such as computing device 100 described with reference to FIG. 1, for example. The components may communicate with each other via a network 212, which may include, without limitation, one or more local area networks (LANs) and/or wide area networks (WANs). Such networking environments are commonplace in offices, enterprise-wide computer networks, intranets, and the Internet. It should be understood that any number of content sharing servers, advertising servers, user devices, and networks may be employed within the system 200 within the scope of the present invention. Additionally, other components not shown may also be included within the system 200.

In the system 200 of FIG. 2, the various user devices 206, 208, 210 may operate to share content via a content sharing service. In particular, each user device 206, 208, 210 may serve as a content contributor by contributing content to the content sharing service. Additionally or alternatively, each user device 206, 208, 210 may operate as a content consumer by using content provided to the content sharing service by content contributors. As shown in FIG. 2, in an embodiment, a content sharing server 202 is provided to facilitate the content sharing service. Although only a single content sharing server 202 is shown in FIG. 2, it should be understood than multiple devices may operate in a distributed computing environment to facilitate the content sharing service. Alternatively, in some embodiments, the content sharing service may operate in a peer-to-peer environment using, for instance, a connected application. Any and all such variations are contemplated to be within the scope of embodiments of the present invention.

In the embodiment of FIG. 2, the content sharing server 202 facilitates the content sharing service by receiving content from a variety of content contributors, for instance, via the user devices 206, 208, 210. When the content sharing server 202 receives content from a content contributor, the content may be associated with a user account for the content contributor. Additionally, the content sharing server 202 parses the content to identify items for which affiliate advertising links may be added to the content. Affiliate advertising links are then added to the content based on the identified items. As will be described in further detail below, adding an affiliate advertising link to content may be performed in a variety of different manners within the scope of the present invention and may include, for instance, converting an existing URL in the content to an affiliate advertising link or creating an affiliate advertising link and inserting the affiliate advertising link into the content. The affiliate advertising link comprises a URL that links to an advertiser's website, such as one maintained by the advertiser server 204, and includes an affiliate ID for the content sharing server.

When a consuming user accesses the content sharing service via the content sharing server 202, the consuming user may consume content published by content contributors. In particular, the consuming user may select an affiliate advertising link added to content published by a content contributor and is navigated to an advertiser's website, for instance, on the advertiser server 204. In some instances, the consuming user may perform an action that results in advertising revenue being generated (e.g., the click-through itself, creating a user account at the advertiser web site, or making a purchase at the advertiser web site). Because the affiliate advertising link selected by the consuming user includes an affiliate ID associated with the content sharing service, the advertising revenue that is generated is allocated to the content sharing service. In some embodiments, the content sharing service may then share at least a portion of the advertising revenue with the content contributor who published the content.

Turning to FIG. 3, a flow diagram is illustrated which shows an exemplary method 300 for adding affiliate advertising links to content provided to a content sharing service from a content contributor in accordance with an embodiment of the present invention. Initially, as shown at block 302, a user account with the content sharing service is created for the content contributor. Generally, a content contributor may access the content sharing service via a web site, web service, or connected application provided by the content sharing service. After accessing the content sharing service, the content contributor provides information to create the user account. Additionally, the content contributor may agree to terms of service.

As shown at block 304, the content sharing service receives content from the content contributor. The content contributor may publish content to the content sharing service in a variety of different manners within the scope of embodiments of the present invention. By way of example and not limitation, in one embodiment, the content contributor may create or otherwise obtain the content prior to accessing the content sharing service. The content contributor may then access the content sharing service and provide the content to the service. For instance, suppose that a content contributor has joined a recipe-sharing service and wishes to publish a lasagna recipe. The content contributor may have generated the recipe (e.g., including a list of ingredients, directions, description, and a picture) using an application separate from the content sharing service. The content contributor then transfers the recipe from the separate application to the content sharing service. In other embodiments, the content contributor may generate the content using the content sharing service, for instance, by typing in the list of ingredients, directions, and description. In some cases, the content contributor may create content by dragging or otherwise adding links to other sites that may support the content. For instance, in the lasagna recipe example, the content contributor may include in the list of ingredients links to a grocery store website at which users may purchase the ingredients.

After receiving the content from the content contributor, the content sharing service parses the content to identify items for adding affiliate advertising links, as shown at block 306. As indicated previously, different types of items, such as, for instance, URLs, text, or images, may be identified for adding affiliate advertising links. A variety of different approaches may be employed for parsing the content in various embodiments of the invention. By way of example and not limitation, one such approach would be to parse the content for keywords from a list of known products available from affiliate partners. Another approach may be to look for known URL formats for existing affiliates links or for known URL links to partner websites. For instance, in the lasagna recipe example, the recipe may be parsed and each ingredient item may be identified as a separate item for adding an affiliate advertising link to the recipe. In some instances, a line item in the recipe may point to a product on a grocery website. The line item may be recognized and replaced with an affiliate advertising link to the same product on the grocery website.

As shown at block 308, after identifying items within the content, affiliate advertising links are added to the content for the identified items. Adding affiliate advertising links may be accomplished in a number of different ways within the scope of the present invention. By way of example only and not limitation, in one embodiment, a text item may be converted into contextual inline link comprising the affiliate advertising link. In another embodiment, a URL within the content may be edited to include an affiliate advertising identifier, thereby converting the URL to an affiliate advertising link. Any and all such variations are contemplated within the scope of embodiments of the present invention.

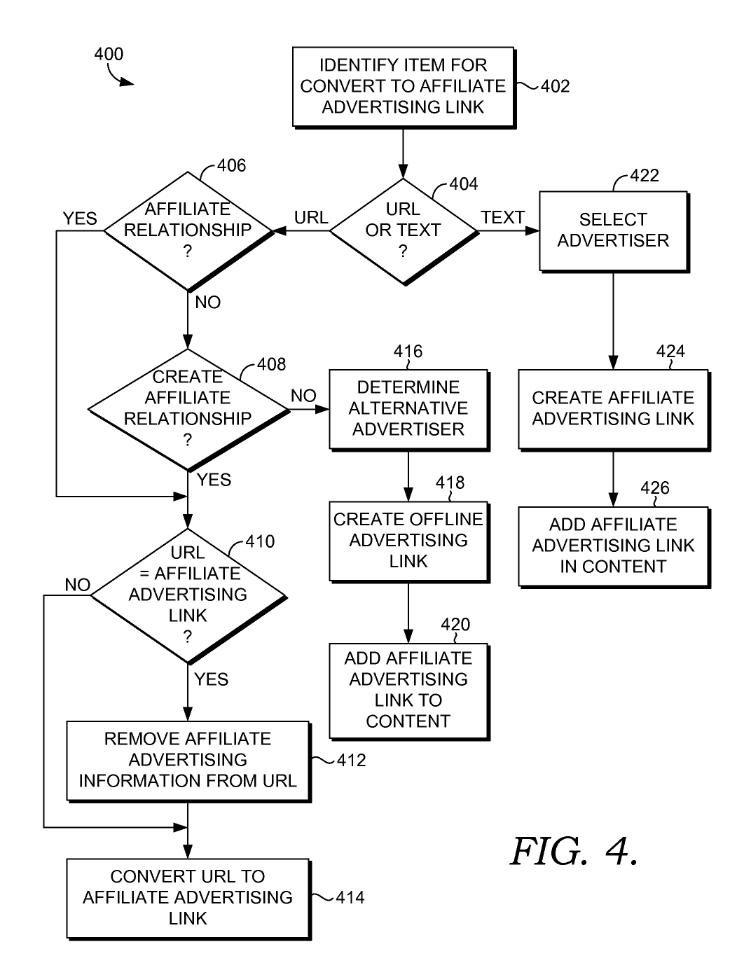

FIG. 4 provides a flow diagram that illustrates one exemplary method 400 for adding an affiliate advertising link for a content item in accordance with an embodiment of the present invention. Initially, as shown at block 402, a content item is identified for adding an affiliate advertising link. Additionally, it is determined whether the content item comprises a URL or text, as shown at block 404. As indicated previously, other types of content items (e.g., images) may be identified in various embodiments of the present invention. If the content items comprises a URL, at block 406, it is determined whether the content sharing service currently has an affiliate relationship with an affiliate advertising program for an advertiser associated with the URL. For instance, in the example of a content contributor providing a lasagna recipe, the content contributor may have included for each ingredient a URL that links to a particular grocery store website. Accordingly, the content sharing service would determine whether it has an affiliate relationship with an affiliate advertising program that includes that particular grocery website. If the content sharing service does not have an affiliate relationship, the content sharing service attempts to create an affiliate relationship, as shown at block 408.

If an affiliate relationship exists at block 406 or an affiliate relationship is created at block 408, the method continues at block 410. In particular, it is determined whether the URL in the content currently comprises an affiliate advertising link. For instance, the content contributor who provided the lasagna recipe may have included affiliate advertising links in the recipe that include the content contributor's own affiliate ID. If the URL comprises an affiliate advertising link with an affiliate ID other than one associated with the content sharing service, the affiliate ID is removed from the URL, as shown at block 412. At block 414, the URL is converted to an affiliate advertising link having an affiliate ID associated with the content sharing service.

As represented at block 408, in some cases, an affiliate relationship cannot be created for an advertiser associated with a URL included in content from a content contributor. For instance, in the lasagna recipe example, the grocery store website linked to in the recipe may not have an affiliate advertising program. Accordingly, if an affiliate relationship cannot be created for the advertiser associated with the URL in the content, an alternative advertiser may be selected, as shown at block 416. An affiliate advertising link for the selected alternative advertiser is then created, as shown at block 418. The affiliate advertising link is then added to the content, as shown at block 420. In some embodiments, the URL placed in the content by the content contributor may be removed and the affiliate advertising link added into the content in its place. In other embodiments, the URL may be left in the content, and the affiliate advertising link may simply be an additional link added to the content.

Returning back to block 404, if it is determined that the content item identified for adding an affiliate advertising link is a text item, an advertiser for creating an affiliate advertising link is selected at block 422. In some embodiments, a database that maps terms to preferred advertisers may be provided for selecting an advertiser. In particular, an advertiser may be selected by referring to the database and looking up an advertiser based on terms from the identified content item. In some embodiments, the identified content item or surrounding contextual information may identify a particular advertiser, although the content item doesn't actually include a link to the advertiser. For instance, in the lasagna recipe example, the content contributor may have identified a preferred grocery store with the list of ingredients. In such embodiments, the identified advertiser may be selected for creating an affiliate advertising link (e.g., if an affiliate advertising relationship exists or may be created).

As shown at block 424, an affiliate advertising link for the identified content item is created based on the selected advertiser. The affiliate advertising link is then added to the content, as shown at block 426. In some embodiments, the identified content items is converted into a contextual inline link comprising the affiliate advertising link. In other embodiments, the affiliate advertising link may be added separate from the content item.

Some embodiments of the present invention may facilitate maximizing advertising revenue by identifying advertisers that provide higher compensation and using affiliate advertising links associated with those advertisers. In particular, the content sharing service may analyze competing affiliate advertising programs to identify the advertiser that would provide the highest level of compensation. This may be performed when the content sharing service selects an advertiser (e.g., when an advertiser is not identified from the content or when an affiliate relationship cannot be created with an advertiser identified from the content). Additionally, even if an advertiser is identified from the content and an affiliate advertising relationship with that advertiser exists or may be created, the content sharing service may identify an alternative advertiser that would provide higher compensation. For instance, in the lasagna recipe example, the content contributor may have included URLs to a grocery store website preferred by the content contributor. However, the content sharing service may have an affiliate advertising relationship with another grocery store that provides higher compensation. In some embodiments, the content sharing service automatically uses the alternative advertiser providing a higher compensation. In other embodiments, the content sharing service recommends using the alternative advertiser and allows the content contributor to determine whether to use that alternative advertiser. In some embodiments of the invention, the content sharing service may provide reports to the content contributor identifying various advertisers that may be employed for a particular affiliate advertising link and indicating the compensation models and projected compensation for each advertiser. The content contributor may then review the information and select an advertiser.

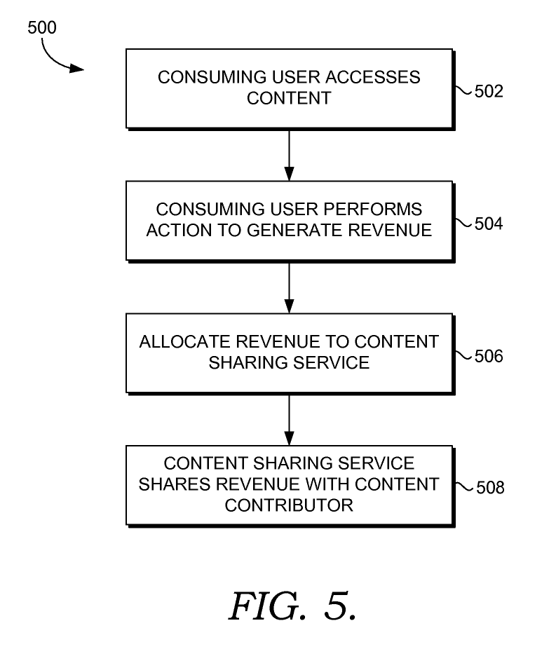

Referring now to FIG. 5, a flow diagram is provided illustrating an exemplary method 500 for sharing advertising revenue with a content contributor in accordance with an embodiment of the present invention. Initially, as shown at block 502, a consuming user accesses content previously provided to a content sharing service by a content contributor. The consuming user then performs an action that generates advertising revenue, as shown at block 504. The action required to be performed by the consuming user to generate advertising revenue depends on the revenue model employed by the affiliate advertising program associated with an affiliate advertising link. For instance, if the affiliate advertising program uses a pay-per-click compensation model, a consuming user clicking an affiliate advertising link generates revenue. In the case of an affiliate advertising program using a pay-per-lead compensation model, a consuming user clicking an affiliate advertising link and performing an action at the advertiser's web site (e.g., creating a user account) would generate revenue. Further, in the case of an affiliate advertising program using a pay-per-sale compensation model, a consuming user clicking an affiliate advertising link and completing a sale at the advertiser's web site would generate revenue.

Because the affiliate advertising link included in the content accessed by the consuming user includes an affiliate ID associated with the content sharing service, the advertising revenue generated by the consuming user's actions are allocated to the content sharing service, as shown at block 506. The content sharing service then allocates at least a potion of the advertising revenue to the content contributor, as shown at block 508.

To illustrate the above method 500 by continuing the lasagna recipe example described above, suppose that a consuming user is searching for a lasagna recipe. The consuming user visits the recipe-sharing service at which the content contributor previously published a lasagna recipe. The consuming user reviews the recipe and sees that there are links to a grocery store website where the consuming user can purchase all the ingredients included in the recipe. Recognizing the convenience of the links in the recipe, the consuming user employs the links to purchase the ingredients indicated in the recipe. The grocery store website recognizes that the consuming user employed the affiliate advertising links and provides compensation based on its affiliate advertising program. Because the affiliate advertising links in the lasagna recipe include an affiliate ID associated with the recipe-sharing service, the advertising revenue is allocated to the service. The recipe-sharing service then shares the advertising revenue with the content contributor who provided the lasagna recipe.

In embodiments, a content sharing service may include affiliate advertising links for a common advertiser or affiliate advertising program in content received from a number of different content contributors. For instance, a recipe-sharing service may include affiliate advertising links to a particular grocery store website in content from a variety of content contributors. Accordingly, the content sharing service may need to determine how to share advertising revenue received from a particular advertiser with all content contributors whose content includes an affiliate advertising link associated with that advertiser. The following provides non-limiting illustrative approaches for determining how to share advertising revenue from a common advertiser or affiliate advertising program with multiple content contributors. However, it should be understood that other approaches are contemplated to be within the scope of embodiments of the present invention.

In some embodiments, a content sharing service may maintain only a single affiliate advertising identifier for an affiliate advertising relationship with a particular advertiser. The affiliate advertising identifier is then included in all affiliate advertising links for that advertiser. When the content sharing service receives advertising revenue from the advertiser, the content sharing service may share the advertising revenue with the content contributors having those affiliate advertising links in a number of ways. In some cases, the content sharing service may simply share an equal amount of the advertising revenue with all content contributors who provided content that includes affiliate advertising links for the advertiser. Clearly, this approach doesn't account for the actual use of affiliate advertising links in the content from the various content contributors.

In another approach in which a content sharing service only maintains a single affiliate advertising identifier for an advertiser, the content sharing service may track click-throughs generated by the various content contributors' content. The content sharing service may then share advertising revenue with each content contributor based on the contributor's click-throughs as a percentage of all click-throughs for that advertiser from the content sharing service. This provides an accurate approach when an advertiser employs a pay-per-click compensation model as each content contributor receives a share of the advertising revenue based on click-throughs. However, this approach is inaccurate when an advertiser employs another compensation model such as a pay-per-lead basis or a pay-per-sale basis. For instance, a first content contributor whose content generates a large number of click-throughs but only minimal sales would receive a higher share of the advertising revenue than a second content contributor whose content generates a relatively smaller number of click-throughs but higher sales. However, if the advertiser employs a pay-per-sale compensation model, the actual advertising revenue generated by the second content contributor would be higher than that generated by the first content contributor.

In some embodiments, a content sharing service may maintain multiple affiliate IDs with a particular advertiser to track the actual revenue generated by affiliate advertising links for each content contributor. For instance, in one embodiment, a content sharing service may maintain an affiliate ID with an advertiser for each content contributor having an affiliate advertising link to that advertiser. The content sharing service then associates each affiliate ID with a corresponding content contributor. When the content sharing service receives advertising revenue from the advertiser based on a particular affiliate ID, the content sharing service determines the content contributor associated with that affiliate ID and shares the advertising revenue with that content contributor.

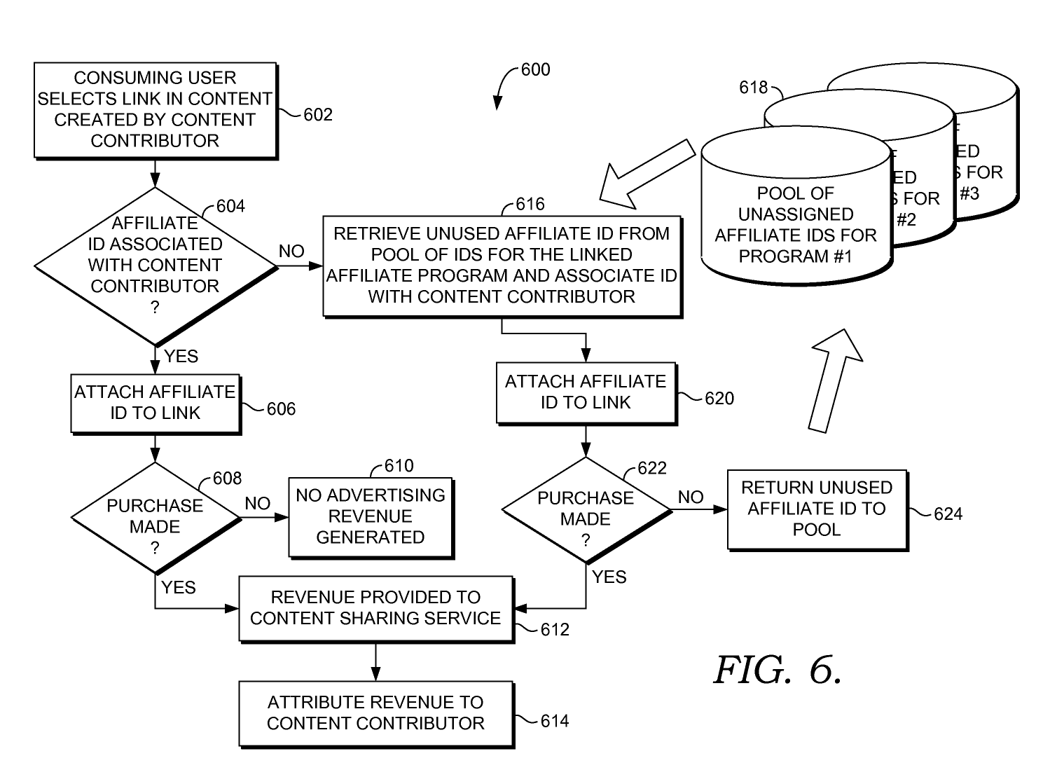

In a further embodiment, to prevent the content sharing service from maintaining an inordinate number of affiliate IDs, the content contributor may instead use of pool of a finite number of affiliate advertising identifiers. For instance, with reference to FIG. 6, a flow diagram is provided that shows an exemplary method 600 for using a pool of affiliate IDs to track advertising revenue generated from an advertiser that uses a cost-per-sale compensation model in accordance with an embodiment of the present invention. Initially, as shown at block 602, a consumer selects a link included in content provided by a content contributor. At block 604, it is determined whether an affiliate ID for an advertiser associated with the link is already associated with the content contributor. If an affiliate ID is already associated with the content contributor, that affiliate ID is used in the selected link. In some cases, the selected link may already include the affiliate ID. In other cases, the affiliate ID is added to the link, as shown at block 606. After the consuming user who selected the link is navigated to the advertiser's website, the consuming user may make a purchase, as represented at block 608. If a purchase isn't made, no advertising revenue is generated, as shown at block 610. Alternatively, if a purchase is made, revenue is generated and allocated to the content sharing service at block 612. The content sharing service may then identify the content contributor associated with the affiliate ID and attribute the revenue to the identified content contributor, as shown at block 614.

If at block 604, it is determined that a affiliate ID is not already associated with the content contributor, an unused affiliate ID is retrieved from a pool of affiliate IDs 618 associated with the advertiser and maintained by the content sharing service, as shown at block 616. The retrieved affiliate ID is also associated with the content contributor. At block 620, the retrieved affiliate ID is attached to the link. After the consuming user who selected the link is navigated to the advertiser's website, the consuming user may make a purchase, as represented at block 622. If a purchase isn't made by the consuming user, the unused affiliate ID is returned to the pool of affiliate IDs 618 and the content contributor is unassociated with the affiliate ID, as shown at block 624. Alternatively, if a purchase is made, revenue is generated and allocated to the content sharing service at block 612. The content sharing service may then identify the content contributor associated with the affiliate ID and attribute the revenue to the identified content contributor, as shown at block 614. In some embodiments, after a purchase has been made, the affiliate ID remains associated with the content contributor for the lifetime of the account. In other embodiments, the affiliate ID is returned to the pool of affiliate IDs 618 if it is not reused (i.e., another purchase made) within a predetermined period of time.

As can be understood, embodiments of the present invention provide for the generation of advertising revenue at content sharing services from affiliate advertising programs. Additionally, in some embodiments, advertising revenue generated by a content sharing service is shared with a content contributor.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable media embodying computer-useable instructions for performing a method of automatically generating affiliate advertising links for content provided by a content contributor to a content sharing service, the method comprising:
receiving content associated with the content contributor at the content sharing service;
parsing the content to identify one or more items within the content; and
adding at least one affiliate advertising link to the content based on at least one of the items identified within the content, the at least one affiliate advertising link being associated with the content sharing service such that revenue generated via the affiliate advertising link is allocated to the content sharing service.

2. The one or more computer-readable media of claim 1, wherein at least one item within the content is a uniform resource locator (URL), and wherein adding at least one affiliate advertising link to the content comprises converting the URL to an affiliate advertising link.

3. The one or more computer-readable media of claim 2, wherein converting the URL to an affiliate advertising link comprises removing the URL from the content and adding an affiliate advertising link to the content.

4. The one or more computer-readable media of claim 2, wherein converting the URL to an affiliate advertising link comprises editing the URL to create the affiliate advertising link.

5. The one or more computer-readable media of claim 4, wherein converting the URL to an affiliate advertising link comprises editing the URL to include an affiliate advertising identifier for the content sharing service.

6. The one or more computer-readable media of claim 2, wherein converting the URL to an affiliate advertising link comprises:
determining that the content sharing service does not have an affiliate relationship with an advertiser associated with the URL; and
creating an affiliate relationship between the content sharing service and the advertiser associated with the URL.

7. The one or more computer-readable media of claim 2, wherein converting the URL to an affiliate advertising link comprises:
determining that the URL comprises an affiliate advertising link associated with an entity other than the content sharing service; and
replacing the URL with an affiliate advertising link associated with the content sharing service.

8. The one or more computer-readable media of claim 7, wherein replacing the URL with an affiliate advertising link associated with the content sharing service comprises editing the URL to remove an affiliate advertising identifier associated with the entity other than the content sharing service and adding an affiliate advertising identifier associated with the content sharing service.

9. The one or more computer-readable media of claim 2, wherein converting the URL to an affiliate advertising link comprises:
selecting an alternative advertiser that differs from an advertiser associated with the URL; and
creating an affiliate advertising link associated with the alternative advertiser.

10. The one or more computer-readable media of claim 9, wherein selecting an alternative advertiser comprises determining that an affiliate advertising link for the alternative advertiser would generate higher revenue than an affiliate advertising link for the advertiser associated with the URL.

11. The one or more computer-readable media of claim 1, wherein at least one item within the content comprises text, and wherein adding at least one affiliate advertising link to the content comprises adding an affiliate advertising link based on the text.

12. The one or more computer-readable media of claim 11, wherein adding an affiliate advertising link based on the text comprises:
selecting an advertiser based on the text;
creating an affiliate advertising link associated with the selected advertiser; and
inserting the affiliate advertising link within the content.

13. A method for sharing advertising revenue generated by a content sharing service with a content contributor, the method comprising:
receiving content at the content sharing service from the content contributor;
parsing the content to identify one or more items for inserting one or more affiliate advertising links;
adding at least one affiliate advertising link to the content, the at least one affiliate advertising link being associated with the content sharing service;
receiving at least an allocation of advertising revenue at the content sharing service from at least one advertiser associated with the at least one affiliate advertising link; and
sharing at least a portion of the advertising revenue with the content contributor.

14. The method of claim 13, wherein the method further comprises:
communicating the content including the at least one affiliate advertising link to a computing device associated with a consuming user; and
receiving a selection of the at least one affiliate advertising link, wherein the consuming user performs an action that generates advertising revenue attributed to the at least one affiliate advertising link.

15. The method of claim 14, wherein the action comprises the selection of the at least one affiliate advertising link.

16. The method of claim 14, wherein the action comprises a purchase.

17. The method of claim 13, wherein sharing at least a portion of the advertising revenue with the content contributor comprises tracking advertising revenue generated by the at least one affiliate advertising link inserted into the content provided by the content contributor and sharing at least a portion of the tracked advertising revenue with the content contributor.

18. A computer-implemented method for tracking advertising revenue generated by affiliate advertising links inserted into content provided by content contributors to a content sharing service, the method comprising:
receiving content from a content contributor at the content sharing service;
parsing the content to identify at least one item for inserting an affiliate advertising link;
providing a link in the content without including an affiliate advertising identifier in the link;
receiving a selection of the link from a consuming user;
retrieving an affiliate advertising identifier from a pool of affiliate advertising identifiers for an affiliate advertising program;
attaching the retrieved affiliate advertising identifier to the link to create an affiliate advertising link; and
associating the retrieved affiliate advertising identifier with the content contributor, thereby allowing for advertising revenue generated based on the affiliate advertising link to be tracked and associated with the content contributor.

19. The method of claim 18, wherein the method further comprises:
determining that an action has not been performed by the consuming user that results in generation of advertising revenue; and
returning the affiliate advertising identifier to the pool of affiliate advertising identifiers.

20. The method of claim 18, wherein the method further comprises:
determining that an action has been performed by the consuming user that results in generation of advertising revenue; and
maintaining the affiliate advertising identifier in the affiliate advertising link.
